(19) United States
(12) Patent Application Publication
(10) Pub. No.: US 2006/0262143 A1
(43) Pub. Date: Nov. 23, 2006

(54) Multi-Image Rotation on an Individual Video and/or Graphic Display

(75) Inventor: Paul Edward Harris, Morganville, NJ (US)

Correspondence Address: Mr.Paul Edward Harris, 205 Commercial Court, Morganville, NJ, 07751, US

(73) Assignee: Mr. Paul Edward Harris, Morganville, NJ (US)

(21) Appl. No.: 10/908,676

(22) Filed: May 23, 2005

(51) Int. Cl. G09G 5/00

(52) U.S. Cl. 345/649; 345/660

(57) ABSTRACT

An electronic device for providing scaling and rotation capabilities by scaling the incoming sources then either rotating the sources followed by combining the images or combining the images then rotating the combined images. The result will be multiple images viewed from a vertically mounted display that are larger as a result of using more of the effective pixel area.

The invention relates to multiple images from the same or different sources to be displayed on an individual video/graphic display that has been mounted in a way where the vertical size is larger than the horizontal. If the display is mounted vertically (portrait), rotating the incoming source(s) and stacking the incoming source(s) one on top of the other allows more of the effective pixel area to be used and creates a larger image versus a typical side by side horizontal (landscape) application. Since the invention manipulates the incoming video/graphic image real time, with the exception of any delays inherent of the inventions process, there is no need to pre-format the content into the new orientation.

The invention could carry out this process in many different ways but in the end the visual effect on the display will be the same. The supplied drawings demonstrate some methods to accomplish the effect of the invention. The order of the process will determine the complexity of the circuit and amount of memory needed. During either process it may be necessary to rescale the images to fit the new proportions based on the input resolution versus the output resolution. Memory for storing field(s) or frame(s) may be necessary as the images will need to be synchronized in order to combine the images together. The block diagrams (FIG. 7 through FIG. 12) represents the basic building blocks required of the circuit. Achieving the result will require multiple processes that over time may be accomplished with fewer semiconductors as technology integrates the functionality of these processes. In all a video decoder, analog to digital converter, digital to analog converter, memory, microcontroller, video encoder, scaler, logic timing circuit or code for combining and/or rotating (FPGA, CPLD, DSP, etc), or any other interface which allows digital connects (DVI, HDMI, LVDS, etc). The overall process can be done with one or many semiconductors including all or requiring some but the technique used to achieve the final result remains the same.

### Definition List 1

| Term | Definition |
|---|---|
| Input Signal | A video or graphic image to be processed. The input |
| | signal can be of any resolution or timing as well |
| | as any format. |
| Output Signal | The end result of the image from the invention. |
| | The output can be a video or graphic image of any |
| | resolution or timing as well as any format. |
| Scaler | A device which converts between video/graphic |
| | formats and/or resolutions/timing. Image is usually |
| | magnified or reduced in order to accommodate new |
| | resolution and/or timing. |
| Combiner | A device which combines 2 or more video/graphic |
| | images together to form 1 complete image comprised |
| | of the original images. |
| Rotation Engine | A device which can rotate an image in any degree |
| | increment or decrement. This device would typically |
| | rotate an image 0, 90, 180, or 270 degrees but is |
| | not necessarily limited to lesser or greater degrees |
| | of increments or decrements. |
| Content | Video or graphic information sent by a device to |
| | provide static or animated images. The information |
| | may be in a format or resolution which will need |
| | to be decoded. |
| Source | A device in which the content is derived from. |
| Display Device | A device which is capable of displaying video |
| | and/or graphic images. Examples of such a device |
| | might be CRT, Plasma, LCD, OLED, DLP Projection, |
| | LCD Projection, or any other technology capable |
| | of showing static or moving video/graphic images. |

### DESCRIPTION OF DRAWINGS

FIG. 1 is a display device showing normal viewing (before rotation processing) along with the X and Y locations for orientation of an image or images in relation to the mounting of the display.

FIG. 2 is three different images from sources (ex. Computer, VCR, DVD, etc) before being displayed or processed. These different sources are represented with the text Image 1, Image 2, and Image 3 and can be of any source type. The word “image” represents the orientation of the video/graphic content on the display and applies to the other figures supplied in the description of drawings and drawings section of this patent.

FIG. 3 is the display device mounted as 90 degrees or 270 degrees compared to the 0 degree mounting as in FIG. 1. It shows what an image would look like before rotation processing if screen was rotated.

FIG. 4 demonstrates examples of the invention's multi-image rotation with two and three images, although any number of images may be used. The left most demonstrates a dual stacked image, the middle is tri stacked, and the right most is dual stacked with both images opposite of each other. The images are rotated 90 or 270 degrees depending on mounting of display as per FIG. 3.

FIG. 5 is a display device showing normal viewing (before rotation processing) with two images side by side. This example demonstrates the unused portions of the display if the aspect ratio of the incoming image(s) is maintained.

FIG. 6 is a display device showing normal viewing (before rotation processing) with three images side by side. This example demonstrates the unused portions of the display if the aspect ratio of the incoming image(s) is maintained.

FIG. 7 is a block diagram of a circuit which scales (resizes) the two images first, combines the two then rotates the combined image.

FIG. 8 is a block diagram of a circuit which scales (resizes) the two images first, next rotates each image separately, than combines.

FIG. 9 is a block diagram of a circuit which scales (resizes) the images first, combines using internal PAP (Side by Side) capabilities then rotates the combined image.

FIG. 10 is a block diagram of a circuit which scales (resizes) the three images first, combines the three then rotates the combined image.

FIG. 11 is a block diagram of a circuit which scales (resizes) the three images first, next rotates each image separately, than combines.

FIG. 12 is a block diagram of two circuits which scales (resizes) the images first, combines using internal PAP (Side by Side) capabilities then rotates the combined image. The two circuits are then combined together to make a single output of up to four images in this particular block diagram.

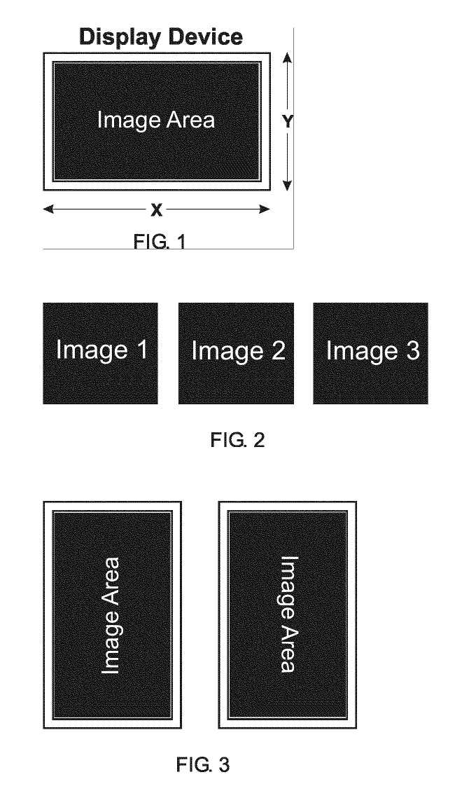

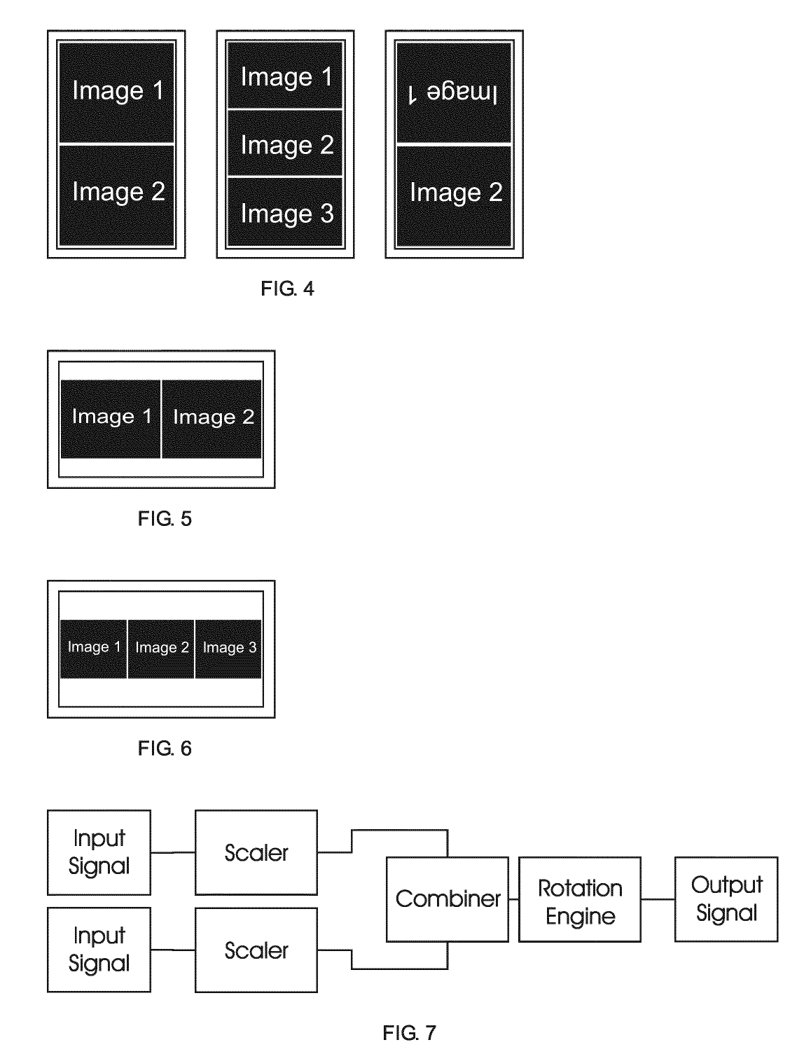

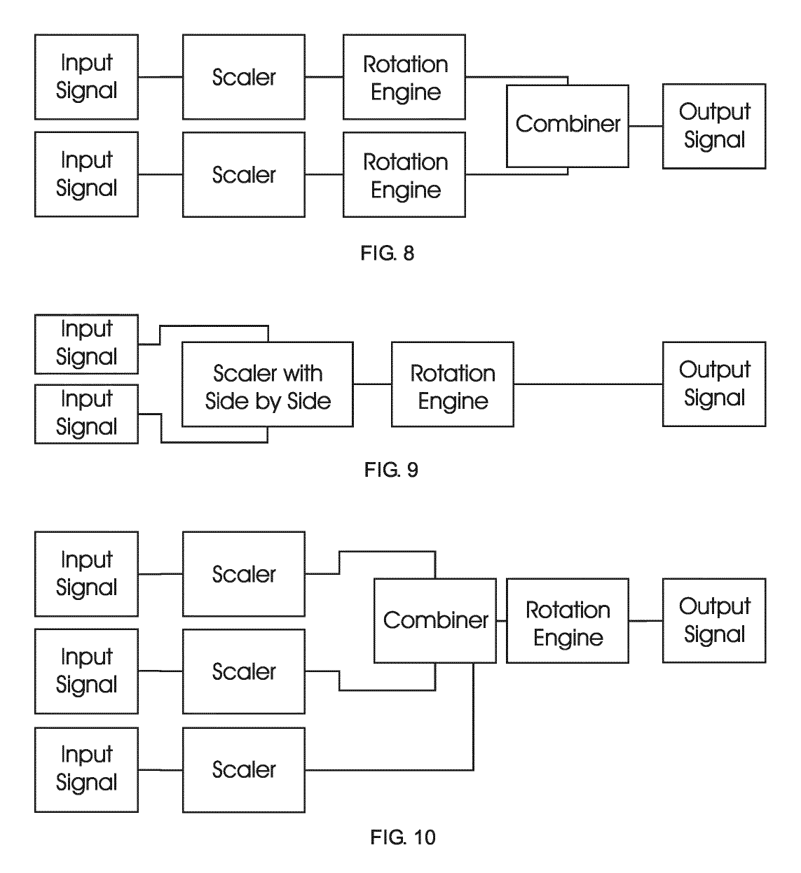

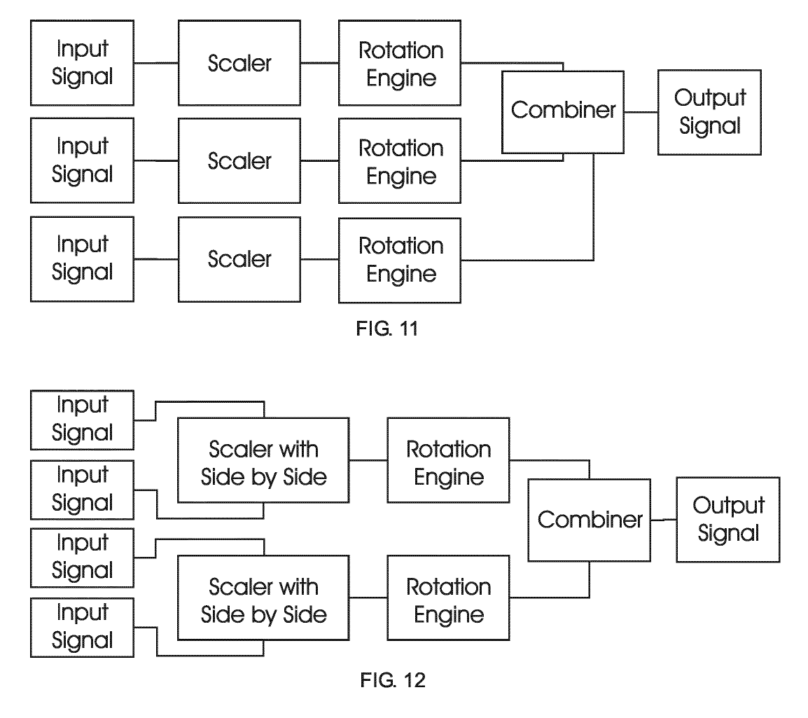

1-2. (canceled)

3. An electronic device comprising:
the ability to rotate and resize multiple static or animated video or graphic information sent by a device in real time 90 or 270 degrees of its original orientation, combined, then retransmitted to be viewed simultaneously on an individual display device.
